(19) United States
(12) Patent Application Publication
(10) Pub. No.: US 2009/0316903 A1
(43) Pub. Date: Dec. 24, 2009

(54) TIME SYNC-TYPE OTP GENERATION DEVICE AND METHOD FOR MOBILE PHONES

(76) Inventor: Gyun Tae Jeung, Seoul (KR)

Correspondence Address: LADAS & PARRY LLP, 26 WEST 61ST STREET, NEW YORK, NY, 10023, US

(21) Appl. No.: 12/295,340

(22) PCT Filed: Apr. 18, 2007
(86) PCT No.: PCT/KR2007/001879

§ 371 Date: Apr. 15, 2009

(30) Foreign Application Priority Data
May 1, 2006 (KR) 10-2006-0039159

(51) Int. Cl. H04K 1/00

(52) U.S. Cl. 380/271

(57) ABSTRACT

The present invention relates to a time sync-type One-Time Password (OTP) generation device and method for a mobile phone. The present invention is configured such that an IC chip, in which a serial number and a secret key for OTP generation are encoded and stored, is mounted in an IC interface provided in the battery mounting part of a mobile phone, and is configured such that a decoding unit for encoding the serial number and secret key of the IC chip, a time counter for counting time information provided from a base station, and an OTP generation module for generating OTP numbers using the time information, the serial number and the secret key as a key value for an OTP program are included in the mobile phone. Accordingly, in accordance with the present invention, it is not necessary for a user to carry a separate OTP generation terminal, and concerns with respect to the hacking of OTP numbers can be alleviated because a serial number and a secret key are stored in an IC chip that cannot be hacked. Furthermore, OTP numbers are generated using time information that is provided by a satellite and is transmitted via a base station, so that no time error relative to a financial institute server occurs, therefore errors in generated time sync-type OTP numbers can be eliminated.

### TECHNICAL FIELD

The present invention relates to a technology of generating and authenticating an authentication number for personal authentication when a financial institute system is accessed.

### BACKGROUND ART

The term ‘OTP’ is an acronym for “one-time password,” and generally refers to an authentication method using a single-use password.

As industrialization proceeds, it is necessary to determine whether a given user is a legitimate user in order to use a system and the Internet. Conventionally, the user authentication task is performed using a user IDentification (ID) and a password.

However, as techniques for detecting the IDs and passwords of users through hacking have developed, such passwords become insecure information that may be exposed at any time. In order to solve this problem, a single-use password is used for authentication so that the password, once used, cannot be used again.

### DISCLOSURE

### Technical Problem

The OTP is classified as a time sync-type, inquiry/response-type or event-type OTP. Currently, the time sync-type OTP is the most widely used. In order to generate such an OTP, the user must carry a separate OTP generation terminal.

In the time sync-type OTP, authentication is performed in such a way that an OTP password is generated by an OTP generation terminal, which is carried by the user, every minute and is input to an OTP authentication server at the time point at which authentication for the corresponding OTP password is desired.

In the above-described time sync-type OTP, the time in the OTP generation terminal must be synchronized with the time in the OTP authentication server.

However, the conventional technology is problematic in that the inconvenience of use is increased because the user must carry a separate OTP generation terminal, in that it is difficult to precisely synchronize the time in the OTP generation terminal and the time in the OTP authentication server with standard time, and in that the reliability of the OTP numbers generated by the OTP generation terminal is reduced because the time in the OTP generation terminal itself is not precisely synchronized with the standard time in the OTP authentication server.

### Technical Solution

The present invention is configured such that an IC chip, in which a serial number and a secret key for OTP generation are encoded and stored, is mounted in an IC interface provided in the battery mounting part of a mobile phone, and is configured such that a decoding unit for encoding the serial number and secret key of the IC chip, a time counter for counting time information provided from a base station, and an OTP generation module for generating OTP numbers using the time information, the serial number and the secret key as a key value for an OTP program are included in the mobile phone.

### ADVANTAGEOUS EFFECTS

In accordance with the present invention, it is not necessary for a user to carry a separate OTP generation terminal, and concerns with respect to the hacking of OTP numbers can be alleviated because a serial number and a secret key are stored in an IC chip that cannot be hacked. Furthermore, OTP numbers are generated using time information that is provided by a satellite and is transmitted via a base station, so that no time error relative to a financial institute server occurs, therefore errors in generated time sync-type OTP numbers can be eliminated.

### DESCRIPTION OF DRAWINGS

FIG. 1 is a block diagram showing a time sync-type OTP generation device for a mobile phone according to the present invention;

FIG. 2 is a flowchart illustrating a time sync-type OTP generation method for a mobile phone according to the present invention;

FIG. 3 is a diagram showing the state in which an Integrated Circuit (IC) chip, which is applied to the present invention, is installed in a mobile phone; and

FIG. 4 is a diagram showing OTP numbers, which are displayed on the display unit of the mobile phone, and variation in a screen depending on the passage of effective time, according to the present invention.

### DESCRIPTION OF REFERENCE NUMERALS OF PRINCIPAL ELEMENTS

```
  1: RF processing unit
  2: control unit
  3: time counter
  4: key unit
  5: memory
  6: display unit
  7: OTP generation module
  8: decoding unit
  9: IC interface
10: IC chip
11: battery mounting part
12: effective time indication bars
```

### BEST MODE

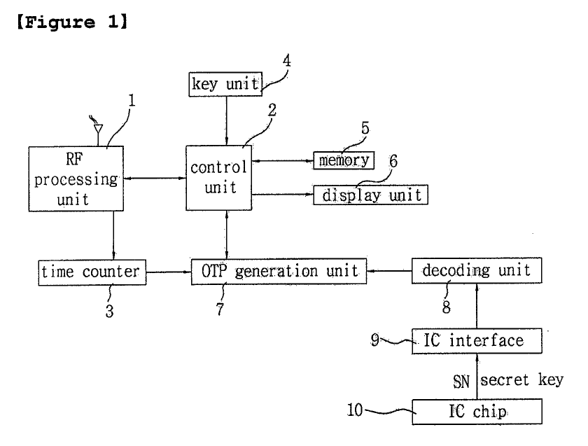

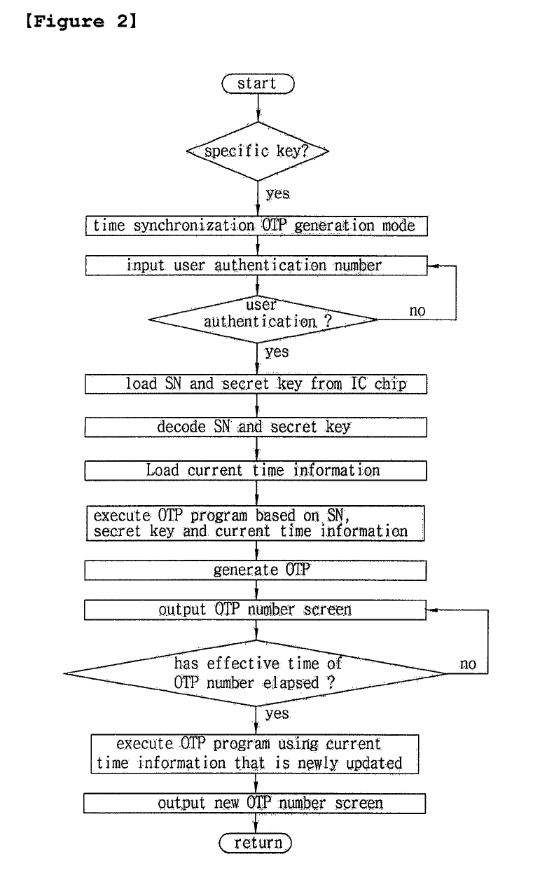

A preferred embodiment of the present invention is described below with the accompanying drawings, that is, FIGS. 1 to 4.

In order to accomplish the above object, the present invention provides a time sync-type OTP generation device for a mobile phone, the mobile phone including a Radio Frequency (RF) processing unit 1 for transmitting and receiving data to and from a base station, a key unit 4 having number keys and a plurality of function keys, memory 5 for storing data and a display unit 6, wherein:

an IC chip 10 in which a serial number and a secret key, which are used for OTP generation, are encoded and stored, is mounted in an IC interface 9 provided in the battery mounting part 11 of the mobile phone, and an OTP program, downloaded from a communication provider server, is stored in the memory 5, wherein the mobile phone includes:

a decoding unit 8 for decoding the serial number and secret key of the IC chip 10;

a time counter 3 for counting standard time information provided from the base station;

an OTP generation module 7 for generating an OTP number using the standard time information, the serial number and the secret key as key values for the OTP program stored in the memory 5; and

a control unit 2 for making a request for the input of a predetermined user authentication number for user authentication after a mode is switched to an OTP generation mode in response to the pressing of a specific key of the key unit 4, causing OTP numbers to be generated by operating the OTP generation module 7 if it is determined that a user is an legitimate user using the authentication number, and causing the generated OTP numbers to be displayed on the display unit 6.

When the OTP numbers are displayed on the display unit 6, a plurality of effective time indication bars 12, which can indicate effective time for each of the displayed OTP numbers, are formed on a side of the screen of the display unit 6, the effective time indication bars 12 being turned off sequentially at predetermined time intervals.

The present invention provides a time sync-type OTP generation method for a mobile phone implemented using hardware, the time sync-type OTP generation method including:

a first step of making a request for the input of a user authentication number after a mode is switched to a time synchronization OTP generation mode, when a specific key provided in a key unit 4 is pressed;

a second step of a user inputting a predetermined user authentication number in response to the request of the first step, and authenticating the user if it is determined that the input authentication number corresponds to an authentication number stored in a memory 5;

a third step of loading a serial number (SN) and a secret key, which are provided from an IC chip 10 connected to an IC interface 9;

a fourth step of a decoding unit 8 decoding the loaded serial number and secret key and supplying decoding results to an OTP generation module 7;

a fifth step of supplying counting results, obtained by a time counter 3 counting standard time information, to the OTP generation module 7;

a sixth step of the OTP generation module 7 executing an OTP program stored in the memory 5, and generating an OTP number using the supplied standard time information, the serial number and the secret key as key values for the OTP program; and

a seventh step of outputting the OTP number, which is generated at the sixth step, through a display unit 6.

The time sync-type OTP generation method further includes, when an effective time elapses after the OTP number is displayed on the display unit 6 at the seventh step, an eighth step of the control unit 2 generating a new OTP number using the elapsed current time information, the serial number and the secret key as key values for the OTP program.

### MODE FOR INVENTION

The operation of the present invention, constructed as described above, is described as follows.

The present invention enables the generation of OTP numbers necessary for authentication using a mobile phone.

The RF processing unit 1 of the mobile phone performs a communication function while communicating with the base station under the control of the control unit 2.

An OTP generating function is performed when a user presses a specific key provided in the key unit 4.

When the user presses the specific key provided in the key unit 4, the control unit 2 makes a request for the pressing of a user authentication number for user authentication after switching the mode to an OTP generation mode in response to the pressing of the specific key. The user inputs the user authentication number by manipulating the key unit 4 in response to the request from the control unit 2.

When the user authentication number is input, the control unit 2 determines whether a user authentication number, which is already stored in the memory 5, and a newly input authentication number coincide with each other. If the authentication numbers coincide with each other, a determination that the current user is a legitimate user is made and authentication is permitted.

Thereafter, the control unit 2 controls the individual components so that the OTP numbers can be generated by the OTP generation module 7.

Under the control of the control unit 2, a serial number and a secret key from the IC chip 10 connected to the IC interface 9 are loaded and supplied to the decoding unit 8. The decoding unit 8 decodes the loaded serial number and secret key and supplies the decoding results to the OTP generation module 7.

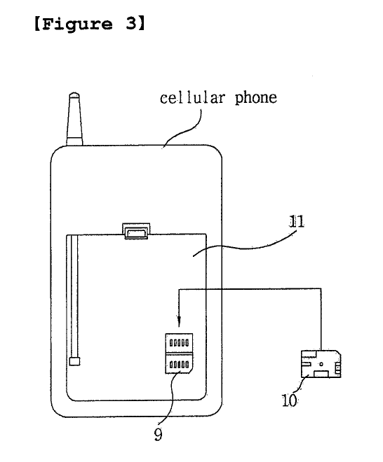

In this case, as shown in FIG. 3, the IC interface 9 is formed on a battery mounting part 11 formed in the rear of the mobile phone, and the IC chip 10, in which the serial number and the secret key are stored after encoding, is mounted in the IC interface 9. Accordingly, data stored in the IC chip 10 can be supplied to the OTP generation module 7 via the IC interface 9.

The information stored in the above-described IC chip 10 cannot be hacked, so that the danger of hacking can be avoided in the case where the IC chip 10 is used for OTP generation which requires security.

Meanwhile, the time counter 3 applied to the mobile phone counts standard time information received from the RF processing unit 1 and supplies the counting results to the OTP generation module 7.

The OTP generation module 7 uses the standard time information, the serial number and the secret key as key values while executing an OTP program that is stored in the memory 5 and, thus, generates an OTP number.

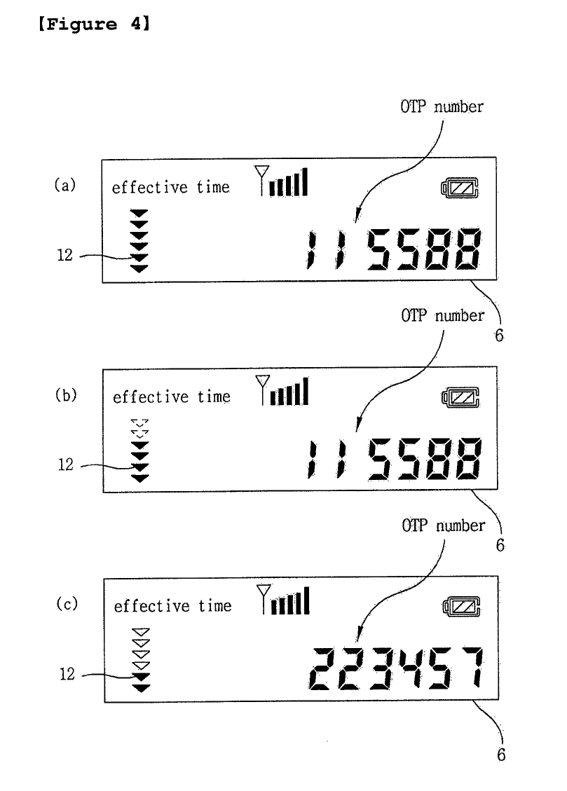

The generated OTP number is displayed on the display unit 6 under the control of the control unit 2, as shown in FIG. 4(a).

The generated OTP number is displayed in the center portion of the display unit 6, and effective time indication bars 12, which are formed of a plurality of inverse triangular bars, are displayed on a side of the display unit 6.

The effective time indication bars 12, as shown in FIG. 4(b), are turned off sequentially at predetermined time intervals of about 10 seconds, and thus the notification of the effective time during which the currently displayed OTP number can be used is provided to the user.

Furthermore, the control unit 2 counts the effective time immediately after the OTP number is displayed on the display unit 6, generates another OTP number in synchronization with a new standard time provided by the time counter 3 when the count of the effective time is completed, and newly displays the latter OTP number, generated as described above, on the display unit 6 as shown in FIG. 4(c).

As described above, the present invention enables time sync-type OTP numbers, which are necessary for authentication for a financial institute, an Internet server and the like, to be generated by a mobile phone, so that it is not necessary for a user to carry a separate OTP number generation terminal and an effect can be expected in which no error occurs in the time sync-type OTP numbers generated using a mobile phone, which is perpetually set to standard time.

### INDUSTRIAL APPLICABILITY

As described above, the present invention is configured such that an IC chip in which a serial number and a secret key for OTP generation are encoded and stored, is mounted in an IC interface provided in the battery mounting part of a mobile phone, and is configured such that a decoding unit for encoding the serial number and secret key of the IC chip, a time counter for counting time information provided from a base station, and an OTP generation module for generating OTP numbers using the time information, the serial number and the secret key as a key value for an OTP program are included in the mobile phone. Accordingly, in accordance with the present invention, it is not necessary for a user to carry a separate OTP generation terminal, and concerns with respect to the hacking of OTP numbers can be alleviated because a serial number and a secret key are stored in an IC chip that cannot be hacked. Furthermore, OTP numbers are generated using time information that is provided by a satellite and is transmitted via a base station, so that no time error relative to a financial institute server occurs, therefore errors in generated time sync-type OTP numbers can be eliminated. As a result, the present invention can be widely used for authentication for financial transactions, authentication for small payments in home shopping malls and authentication for small payments in Internet shopping malls.

### SEQUENCE LIST TEXT

None

1. A time sync-type OTP generation device for a mobile phone, the mobile phone including a Radio Frequency (RF) processing unit (1) for transmitting and receiving data to and from a base station, a key unit (4) having number keys and a plurality of function keys, memory (5) for storing data and a display unit (6), wherein:
an IC chip (10) in which a serial number and a secret key, which are used for OTP generation, are encoded and stored, is mounted in an IC interface (9) provided in a battery mounting part (11) of the mobile phone, and an OTP program, downloaded from a communication provider server, is stored in the memory (5),
wherein the mobile phone comprises:
a decoding unit (8) for decoding the serial number and secret key of the IC chip (10);
a time counter (3) for counting standard time information provided from the base station;
an OTP generation module (7) for generating an OTP number using the standard time information, the serial number and the secret key as key values for the OTP program stored in the memory (5); and
a control unit (2) for making a request for input of a predetermined user authentication number for user authentication after a mode is switched to an OTP generation mode in response to pressing of a specific key of the key unit (4), causing OTP numbers to be generated by operating the OTP generation module (7) if it is determined that a user is a legitimate user using the authentication number, and causing the generated OTP numbers to be displayed on the display unit (6).

2. The time sync-type OTP generation device according to claim 1, wherein, when the OTP numbers are displayed on the display unit (6), a plurality of effective time indication bars (12), which can indicate effective time for each of the displayed OTP numbers, are formed on a side of a screen of the display unit (6), the effective time indication bars (12) being turned off sequentially at predetermined time intervals.

3. A time sync-type OTP generation method for a mobile phone, comprising:
a first step of making a request for input of a user authentication number after a mode is switched to a time sync OTP generation mode, when a specific key provided in a key unit (4) is pressed;
a second step of a user inputting a predetermined user authentication number in response to the request of the first step, and authenticating the user if it is determined that the input authentication number corresponds to an authentication number stored in a memory (5);
a third step of loading a serial number (SN) and a secret key, which are provided from an IC chip (10) connected to an IC interface (9);
a fourth step of a decoding unit (8) decoding the loaded serial number and secret key and supplying decoding results to an OTP generation module (7);
a fifth step of supplying counting results, obtained by a time counter (3) counting standard time information, to the OTP generation module (7);
a sixth step of the OTP generation module (7) executing an OTP program stored in the memory (5), and generating an OTP number using the supplied standard time information, the serial number and the secret key as key values for the OTP program; and
a seventh step of outputting the OTP number, which is generated at the sixth step, through a display unit (6).

4. The time sync-type OTP generation method according to claim 3, further comprising, when an effective time elapses after the OTP number is displayed on the display unit (6) at the seventh step, an eighth step of the control unit (2) generating a new OTP number using the elapsed current time information, the serial number and the secret key as key values for the OTP program.
